(19) United States
(12) Patent Application Publication
(10) Pub. No.: US 2011/0017631 A1
(43) Pub. Date: Jan. 27, 2011

(54) BAMBOO FIBER BABY WIPES

(75) Inventor: Sonja Sheasley, Mashpee, MA (US)

Correspondence Address: WOLF GREENFIELD & SACKS, P.C., 600 ATLANTIC AVENUE, BOSTON, MA, 02210-2206, US

(73) Assignee: BumBoosa, LLC, Mashpee, MA (US)

(21) Appl. No.: 12/842,438

(22) Filed: Jul. 23, 2010

Related U.S. Application Data
(60) Provisional application No. 61/228,531, filed on Jul. 24, 2009.

(51) Int. Cl. B65D 85/00; B32B 9/00; B08B 7/00

(52) U.S. Cl. 206/524.1; 442/159; 134/6

(57) ABSTRACT

The invention relates in some aspects to compositions, e.g., wipes, e.g., sanitary wipes, infant wipes, etc., comprising a bamboo fiber and a isolated essential oil, and methods of use thereof.

### RELATED APPLICATIONS

This application claims priority under 35 U.S.C. §119(e) to U.S. Provisional Application Ser. No. 61/228,531, entitled “BAMBOO FIBER BABY WIPES” filed on Jul. 24, 2009, which is herein incorporated by reference in its entirety.

### BACKGROUND OF INVENTION

A significant portion of disposable wipes are composed of non-biodegradable materials. Such wipes may sit idle in landfills for years when they are disposed of and contribute to the unsightly trash heaps. There remains a need for more eco-friendly to disposable wipes.

### BRIEF SUMMARY OF INVENTION

Aspects of the invention relate in part to the recognition that bamboo fibers and isolated essential oils may be combined to produce biodegradable and sustainable products having exceptional antiseptic and aromatic properties. Accordingly, in some embodiments, the invention provides compositions comprising a bamboo fiber and a isolated essential oil.

According to other aspects, the invention provides methods of cleaning a substrate. In some embodiments, the methods comprise contacting a substrate with a composition comprising a bamboo fiber and an isolated essential oil. Any of the compositions disclosed herein may used in the methods.

According to still other aspects, the invention provides cleaning products. In some embodiments, the cleaning products comprise a container housing a bamboo fiber and an isolated essential oil. Any of the compositions disclosed herein may used in the cleaning products.

### BRIEF DESCRIPTION OF DRAWINGS

FIG. 1 shows product packaging and examples of individual wipes.

FIG. 2 shows an unfolded, individual wipe.

FIG. 3 shows a close-up view of an individual wipe.

### DETAILED DESCRIPTION OF EMBODIMENTS OF THE INVENTION

Aspects of the invention relate in part to the recognition that bamboo fibers and isolated essential oils may be combined to produce biodegradable and sustainable products having exceptional antiseptic and aromatic properties. Accordingly, in some embodiments, the invention provides compositions comprising a bamboo fiber and a isolated essential oil. In some embodiments, the bamboo fibers are in the form of a cloth. In some embodiments, the bamboo fibers are combined with a composition (e.g., a liquid composition) that comprises one or more isolated essential oils. In some embodiments, the composition comprises one or more components that augment the utility of the bamboo fibers. For example, the composition may comprise cleaning agents, detergents, moisturizers, conditioners and skin protectants, etc. The composition may also comprise buffers, diluents, stabilizers, emulsifiers, preservatives and other components useful for ensuring quality, sterility, stability and/or sufficient shelf-life of the composition.

As used herein, the term “bamboo fiber” is a fibrous material obtained from a Bamboo plant. Bamboo fibers typically comprise various micro-gaps and micro-holes that facilitate moisture absorption. Bamboo fibers also typically show a high level of elasticity and strength. It has been found that non-woven bamboo fiber used for a cloth, e.g., a infant wipe, can be unfolded and stretched and is resistant to tearing.

The compositions disclosed herein may comprise fibers of any bamboo species.

The bamboo species may be selected from the group consisting of Acidosasa sp., Ampleocalamus sp., Arundinaria sp., Bambusa sp., Bashania sp., Borinda sp., Brachystachyum sp., Cephalostachyum sp., Chimonobambusa sp., Chusquea sp., Dendrocalamus sp., Dinochloa sp., Drepanostachyum sp., Eremitis sp., Fargesia sp., Gaoligongshania sp., Gelidocalamus sp., Gigantocloa sp., Guadua sp., Hibanobambusa sp., Himalayacalamus sp., Indocalamus sp., Indosasa sp., Lithachne sp., Melocanna sp., Menstruocalamus sp., Nastus sp., Neohouzeaua sp., Neomicrocalamus sp., Ochlandra sp., Oligostachyum sp., Olmeca sp., Otatea sp., Oxytenanthera sp., Phyllostachys sp., Pleioblastus sp., Pseudosasa sp., Raddia sp., Rhipidocladum sp., Sasa sp., Sasaella sp., Sasamorpha sp., Schizostachyum sp., Semiarundinaria sp., Shibatea sp., Sinobambusa sp., Thamnocalamus sp., Thyrsostachys sp., Yushania sp and any other suitable species.

In some embodiments, the bamboo fiber is from a Phyllostachys species, for example Phyllostachys heterocycla pubescens. Phyllostachys heterocycla pubescens, also known as Moso Bamboo, is a hardy Bamboo species, most prevalent in China, which grows very fast with little rainfall. It is to be understood that the compositions disclosed herein are not limited to containing any one bamboo fiber and may comprise a plurality of fibers of different species. For example, the composition may comprise a bamboo from a Phyllostachys heterocycla pubescens and a bamboo from a different species, e.g., a different a Phyllostachys species.

Bamboo fibers of the invention may be in any of variety of forms. Bamboo fibers may be in a cloth form (e.g., a cloth that may be used as a wipe). For example, bamboo fibers may be in the form a non-woven fiber cloth. Bamboo fibers may to alternatively be in the form a woven fiber cloth. Bamboo fibers may also be ground, fragmented, or broken down to a powder or particulate form.

Bamboo fiber may be produced by any appropriate methods known in the art. For example, the bamboo fiber may be produced by chemical processing of crushed bamboo stalk. The chemical processing may comprise treating the crushed bamboo stalk with an appropriate alkaline solution, e.g., NaOH₂. The skilled artisan will be capable of selecting an appropriate alkaline solution. Bamboo fiber may also be produced by mechanical processing of crushed bamboo stalk, which may involve enzymatic digestion of the crushed bamboo stalk.

In some embodiments, bamboo fibers are produced according to a viscose process such as the viscose process typically used to produce rayon. Accordingly, in some embodiments, bamboo fiber may be referred to as “bamboo viscose fiber” or “bamboo from rayon.”

According to aspects of the invention, natural antimicrobial (e.g., antibacterial) agents exist in bamboo and remain in the processed bamboo fiber. In a study by Japan Inspection Association, it was found that even after significant washing, bamboo fiber samples still possess excellent antibacterial function. In another study at the S.S.M. College of Engineering in India, the antibacterial and anti-fungal properties of bamboo were assessed. Based on this analysis, it was recognized that bamboo has good antimicrobial properties when compared with cotton and rayon. Results of various tests, including, rate of growth and survivability of bacteria and fungi, time course analyses of the inhibitory effects against microbes, normal AATCC procedures such as AATCC 30, AATCC 100, AATCC 147 and soil burial tests, confirm that the antimicrobial effects of bamboo samples are comparatively better than the cotton and rayon.

As used herein, the term “essential oil” refers to a hydrophobic liquid containing one or more volatile aromatic compounds of a plant. Typically, an essential oil has a distinctive scent, or essence, of the plant.

As used herein, the term “isolated essential oil” refers to an essential oil that (i) has been separated from at least some of the components with which it was associated when initially produced, and/or (ii) non-naturally produced, prepared, or manufactured. Isolated essential oils may be separated from at least about 10%, about 20%, about 30%, about 40%, about 50%, about 60%, about 70%, about 80%, about 90%, about 95%, about 98%, about 99%, substantially 100%, or 100% of the other components with which they were initially associated. In some embodiments, isolated essential oils are more than about 80%, about 85%, about 90%, about 91%, about 92%, about 93%, about 94%, about 95%, about 96%, about 97%, about 98%, about 99%, substantially 100%, or 100% pure. In some embodiments, the isolated essential oil is not an essential oil of a bamboo plant.

Essential oils may be obtained from commercially available sources, produced synthetically or obtained directly from plants. Essential oils may be extracted from plants using any appropriate method known in the art. For example, as will be appreciated by the skilled artisan, essential oils may be extracted by steam distillation, such as with Lavender essential oil. Other processes include expression, as is used, for example, to obtain Sweet Orange essential oil, or solvent extraction.

Any isolated essential oil may be used in the compositions disclosed herein. For example, the isolated essential oil may be selected from the group consisting of sage, thyme, winter savory, mandarin, grapefruit, bitter orange, sweet orange, lime, lemon, chamomile, dill, lavender, neroli, rose, tarragon, rosemary, peppermint, cinnamon, geranium, rosemary, orange, clove and yarrow essential oils.

Sometimes referred to as the essence of the plant, essential oils may not only protect the plant, but also contribute to its aroma. Essential oils differ in chemical composition from other herbal products because the distillation process typically only recovers lighter phytomolecules. For this reason essential oils are often rich in monoterpenes and sesquiterpenes, as well as other volatile organic compounds (e.g., esters, aromatic compounds, non-terpene hydrocarbons, some organic sulfides, etc.).

Accordingly, the essential oil may comprise an oxide, a phenol, an alcohol, a monoterpene, an ester, an aldehyde, and/or a ketone. Such essential oils may be extremely useful due to their varied antiviral, antibacterial and antiseptic properties. Essential oils comprising monoterpenes may have anti-viral, antiseptic, and/or bacteriocidal properties, but may be irritating to the skin (non-limiting examples include: lemon, pine, frankincense). Essential oils comprising esters may have sedating, fungicidal, and/or bacteriocidal properties and be aromatically pleasing (non-limiting examples include: bergamot, Clary sage, lavender). Essential oils comprising aldehydes may have sedating and antiseptic properties (non-limiting examples include: melissa, lemongrass, cirtronella). Essential oils comprising ketones may ease congestion and/or aid in flow of mucus, but may be toxic (non-limiting examples include: fennel, hyssop, sage). Essential oils comprising alcohols may be antiseptic, bacteriocidal, and/or anti-viral, and have uplifting qualities (non-limiting examples include: rosewood, geranium, rose, sweet orange). Essential oils comprising phenols may have strong bacteriocidal properties and be very stimulating, but may be highly irritating to the skin (non-limiting examples include: clove, thyme, oregano). Essential oils comprising oxides may have expectorant and strong bacteriocidal properties (non-limiting examples include: rosemary, tea tree).

Any appropriate isolated essential oil may be used in the products and compositions disclosed herein. However, as will be appreciated by the skilled artisan, certain essential oils may not be appropriate for some uses, e.g., for use on skin. The skilled artisan will be capable of selecting, formulating and blending oils for a particular application or use of the compositions disclosed herein. For example, to be safe for use as a skin surface wipe, there would typically be an absence of certain toxic compounds and/or toxic concentrations of compounds. Essential oils comprising certain alcohols and/or esters, for example, are typically considered safe and have a very low or totally absent toxic reaction in the body or on the skin.

In the case of a baby wipe specifically created for young skin, it has been found that Sweet Orange oil (Citrus Sinensis) is particularly useful. Sweet Orange essential oil contains roughly 90% of limonene. The International Agency for Research on Cancer classifies d-limonene under Class 3: Not classifiable as to its carcinogenicity or genotoxicity in humans. Citrus essential oils, including Sweet Orange, are typically safe when applied to the skin of a baby or expectant mother as long as they are diluted into a cosmetic base or carrier oil. Citrus oils have exceptionally low molecular weight, which means that most of the essential oil that the skin comes in contact with diffuses into the air and is not actually absorbed into the body. In some embodiments, the chemical composition of sweet orange essential oil is: α-pinene (0.54%), myrcene (2.08%), limonene (95.37%), neral (0.06%), citronellal (0.10%), decanal (0.06%), geranial (0.12%) (Weiss EA. Essential Oil Crops. CAB International, 1997). A major constituent of sweet orange essential oil is limonene. Sweet orange is non-toxic, non-irritating, and non-sensitizing. Sweet orange is not photo-toxic, although bitter orange is photo-toxic. (Leung A, Foster S. Encyclopedia of Common Natural Ingredients used in Foods, Drugs and Cosmetics.) Most alternative citrus oils that blend well with Lavender are phototoxic. Some essential oils contain up to 2% phototoxic furanocoumarins, most to notably those of expressed citrus oils. Although it is commonly believed that all citrus oils are photo-toxic, this is not case; for example Sweet Orange (citrus sinensis), as compared with Bitter Orange (citrus aurantium var amara) which is photo sensitive), Grapefruit (citrus paradisi) and Mandarin (citrus reticulata). Grapefruit or Mandarin are more fragile and their properties break down more quickly than Sweet Orange Oil (citrus sinensis).

Certain scientific studies have concluded that Sweet Orange essential oil possesses antibacterial properties. It has been found that an important characteristic of essential oils and their components is their hydrophobicity, which enables them to partition the lipids of the bacterial cell membrane and mitochondria, disturbing the cell structures and rendering them more permeable. Extensive leakage from bacterial cells or the exit of critical molecules and ions will lead to death. In one study, cinnamon, lime, geranium, rosemary, orange, lemon and clove oils were found to be equally effective against both gram-positive bacteria and gram-negative organisms. Applicant has discovered that Sweet Orange blends well with Lavender, is appropriate for use with children, infants, pregnant or nursing mothers, and can be obtained in a cost-effective manner.

Lavender is a safe and gentle essential oil when compared to others. It also exhibits antibacterial activity. In one study, the antibacterial and antioxidant properties are tested against the twenty-five microorganisms. All the oils possessed antibacterial properties but with different degrees of effectiveness. Thyme, winter savory, lavender and sage oils were inhibitory to the growth of all the microorganisms. Thyme and winter savory oils were the most active and exhibited greatest inhibition against Brevibacteriumlinens, Brochothrix thermosphacta, and Lactobacillus plantarum. This effectiveness can be attributed to the high contents of phenols, thymol and carvacrol in the essential oils which are known to be powerful antibacterial agents (Deans and Svoboda, 1989). Oils from Roman chamomile, tarragon, rosemary and peppermint exhibited no growth inhibition against some of the tested organisms. Although both Lavender and Chamomile would be considered safe for infants, Chamomile does not blend well with Sweet Orange Oil in some formulations, and does not exhibit the same growth inhibition properties that Lavender does. In some embodiments, the isolated essential oil comprises an ester and an alcohol. In one embodiment, the isolated essential oil is a mixture comprising sweet orange and lavender essential oils.

Often the isolated essential oil is a pure or substantially pure (e.g., at least 99.5% pure, at least 99.9% pure) essential oil. However, in some embodiments, the isolated essential oils are not pure. In some embodiments, the isolated essential oil is prepared as a mixture comprising at least one essential oil and a carrier oil. In certain embodiments, the carrier oil is olive, almond, hazelnut or grape seed oil. In some embodiment, the essential oil represent at least about 10%, about 20%, about 30%, about 40%, about 50%, about 60%, about 70%, about 80%, about 90%, about 95%, about 98%, about 99% of the mixture. In certain embodiments, the mixture comprises about 0.1% to about 5% of the essential oil. In certain embodiments, the mixture comprises about 0.1% to about 2% of the essential oil. In certain embodiments, the mixture comprises about 0.1% to about 1% of the essential oil.

In some embodiments, the isolated essential oil is prepared as a mixture comprising at least two different essential oils, and the mixture may or may not comprise a carrier oil.

In some embodiments, the isolated essential oil comprises a citrus essential oil. In certain embodiments, the citrus essential oil is selected from the group consisting of lime, lemon, mandarin, grapefruit, bitter orange, and sweet orange essential oils.

In some embodiments, the isolated essential oil comprises at least one of a-pinene, myrcene, limonene, neral, citronellal, decanal, and geranial.

In some embodiments, compositions are provided that comprise a bamboo fiber and a mixture comprising an isolated essential oil and an aqueous solution. In some embodiments, compositions are provided that comprise a cloth, comprising bamboo fibers, and a mixture, comprising an isolated essential oil and an aqueous solution, that impregnates the cloth. In certain embodiments, the volume of the isolated essential oil ranges from about 0.1% to about 5% of the volume of the mixture. In certain embodiments, the volume of the isolated essential oil ranges from about 0.1% to about 2% of the volume of the mixture. In certain embodiments, the volume of the isolated essential oil ranges from about 0.1% to about 1% of the volume of the mixture. In certain embodiments, the volume of the isolated essential oil is about 1% of the volume of the mixture. In some embodiments, the volume of the isolated essential oil is up to 0.1%, up to 0.2%, up to 0.3%, up to 0.4%, up to 0.5%, up to 0.6%, up to 0.7%, up to 0.8%, up to 0.9%, up to 1%, up to 1.5%, up to 2%, up to 2.5%, up to 3%, up to 3.5%, up to 4%, up to 4.5%, or up to 5% of the volume of the mixture. In some embodiments, the volume of the isolated essential oil is 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, or 5% of the volume of the mixture. In some embodiments, the mixture comprises more than one isolated essential oil and an aqueous solution, it being appreciated that each isolated essential oil may be present at the same concentration or at a different concentration compared with each other isolated essential oil in the mixture.

In some embodiments, compositions are provided that comprise a non-woven bamboo fiber. In other embodiments, compositions are provided that comprise a woven bamboo fiber. In some embodiments, the bamboo fiber is in the form of a cloth, e.g., a cloth wipe, e.g., a sanitary wipe, an infant wipe, a hand wipe, etc. In certain embodiments, the cloth has a length in a range of about 5 cm to about 25 cm and a width in a range of about 10 cm to about 30 cm. In certain embodiments, the cloth has a length in a range of about 5 cm to about 50 cm and a width in a range of about 5 cm to about 50 cm. In certain embodiments, the cloth has a length in a range of about 5 cm to about 200 cm and a width in a range of about 5 cm to about 200 cm. In certain embodiments, the cloth has a length of about 15 cm and width of about 20 cm.

In certain embodiments, the cloth has a weight in a range of about 5 grams per square meter (gsm) to about 25 gsm, about 10 gsm to about 30 gsm, about 20 gsm to about 50 gsm, or about 20 gsm to about 100 gsm. The cloth may have a weight of up to about 5 gsm, about 10 gsm, about 20 gsm, about 30 gsm, about 40 gsm, about 45 gsm, about 50 gsm, about 60 gsm, about 70 gsm, or more.

In some embodiments, compositions are provided that comprise a bamboo fiber, an isolated essential oil and a non-bamboo fiber. In certain embodiments, the non-bamboo fiber is a synthetic fiber. In specific embodiments, the synthetic fiber is selected from the group consisting of acrylic, aramid, carbon, microfiber, modacrylic, nylon, olefin, polyester, polyethylene, polypropylene, spandex, vinalon, and zylon fibers. In certain other embodiments, the non-bamboo fiber is a natural fiber. In specific embodiments, the natural fiber is selected from the group consisting of alpaca, angora, camel hair, cashmere, catgut, chiengora, llama, mohair, rabbit, silk, sinew, spider silk, wool, yak, abacá, coir, cotton, flax, hemp, jute, kenaf, piña, raffia, ramie, sisal, wood, basalt, mineral wool, glass wool, cellulose acetate, art silk, lyocell, modal, rayon, and tencel fibers.

In some embodiments, compositions are provided that comprise Calendula officinalis flower extract. In certain embodiments, Calendula officinalis flower extract is a useful ingredient in a baby wipe solution (e.g., at a 1.0% dilution rate) of the invention. Calendula officinalis flower extract is a well-known garden plant. Aspects of the invention are based on the recognition that Calendula officinalis flower extract has certain medicinal properties and can be used for cosmetic purposes. Constituents of Calendula officinalis flower extract include, among other things: volatile oil, a yellow resin, calendulin, saponins, and a bitter principle, all of which appear to promote wound healing. Thus, Calendula officinalis flower extract may be used on the skin to treat minor skin conditions including cuts, burns, abrasions and dermatitis rash. A small number of animal studies and human studies report that Calendula officinalis flower extract reduces healing time and increases the strength of healed areas. Limited animal research also suggests that Calendula officinalis flower extract may reduce inflammation when applied to the skin.

Calendula officinalis flower extract may be prepared by methods well known in the art. Calendula officinalis flower extract may also be obtained from various commercial sources. Calendula officinalis flower extract may be prepared, for example, by steeping fresh flower/herb in alcohol or glycerin for several weeks. In some embodiments, when properly made, one fluid ounce of fluid extract equals one ounce of fresh flower/herb.

Thus, in some embodiments, compositions are provided that comprise bamboo fibers, e.g., in the form of a cloth, and a mixture comprising an isolated essential oil, Calendula officinalis flower extract, and an aqueous solution. In certain embodiments, the volume of the Calendula officinalis flower extract ranges from about 0.1% to about 5% of the volume of the mixture. In certain embodiments, the volume of the Calendula officinalis flower extract ranges from about 0.1% to about 2% of the volume of the mixture. In certain embodiments, the volume of the Calendula officinalis flower extract ranges from about 0.1% to about 1% of the volume of the mixture. In certain embodiments, the volume of the Calendula officinalis flower extract is about 1% of the volume of the mixture. In some embodiments, the volume of the Calendula officinalis flower extract is up to 0.1%, up to 0.2%, up to 0.3%, up to 0.4%, up to 0.5%, up to 0.6%, up to 0.7%, up to 0.8%, up to 0.9%, up to 1%, up to 1.5%, up to 2%, up to 2.5%, up to 3%, up to 3.5%, up to 4%, up to 4.5%, or up to 5% of the volume of the mixture.

In some embodiments, compositions provided herein comprise a preservative. The term “preservative,” as used herein, refers to an agent or mixture of agents that is used to protect a composition against microbial (e.g., yeast, mold, bacterial) activity. Representative preservatives include, but are not limited to, sodium benzoate, benzoic acid, ethylenediaminetetraacetic acid, sorbic acid, benzethonium chloride, benzalkonium chloride, bronopol, butyl paraben, methyl paraben, ethylparaben, propyl paraben, thiomerosol, sodium propionate, chlorhexidine, chlorobutanol, chlorocresol, cresol, imidurea, phenol, phenylmercuric salts, potassium sorbate, propylene glycol, and mixtures thereof. Preservatives are thus typically provided at a concentration effective for achieving the desired result of preventing against or inhibiting microbial activity. In some embodiments, a composition comprises a preservative (e.g., potassium sorbate, sodium benzoate) at a concentration in a range of 0.1% to 1%. In some embodiments, a composition comprises a preservative at a concentration of about 0.1%, 0.2%, 0.25%, 0.3%, 0.4% or 0.5%.

Methods of Use

According to other aspects, the invention provides methods of cleaning a substrate. In some embodiments, the methods comprise contacting a substrate with a composition comprising a bamboo fiber and an essential oil. Any of the compositions disclosed herein may used in the methods.

In some embodiments, the contacting step sterilizes the substrate. In some embodiments, the substrate is the external surface of the skin of a subject. In certain embodiments, the subject is a human infant. In certain embodiments, the skin is of the face, neck, hands, genitals, buttocks, legs, or feet of the subject. In some embodiments, the substrate is wood, plastic, ceramic, glass or metal. In some embodiments, the substrate is an eating surface. In some embodiments, the eating surface is a table, plate, or feeding tray.

Cleaning Products

According to still other aspects, the invention provides cleaning products. In some embodiments, the cleaning products comprise a container housing a bamboo fiber and an isolated essential oil. Any of the compositions disclosed herein may be used in the cleaning products. In some embodiments, the composition of the cleaning product also comprises an aqueous solution. In some embodiments, the volume of the isolated essential oil and aqueous solution ranges from about 150 and 450 milliliters. In some embodiments, the bamboo fiber, e.g., a non-woven fiber, of the cleaning product is in a cloth form. In some embodiments, the container of the cleaning product houses about 50 to about 100 cloths. In some embodiments, the container houses about 80 cloths.

Containers

Any of a variety of containers may be used to house products and compositions of the invention, including, for example, a tube, a box, a vial, a package, a flask, a jar, etc. The container may be made from any of a variety of materials, including, for example, plastic, paper, cardboard, metal, glass, etc. The container may be biodegradable or non-biodegradable. The container may or may not be resealable. A resealable container may be resealable by any of a variety of means including, for example, a ZipLock seal, an adhesive seal, a screw-cap seal, etc. In some embodiments, the container is a rigid container. In other embodiments, the container is a flexible container. It should be appreciated that the container is no limited to those disclosed herein and any appropriate container may be used.

### EXAMPLES

### Example 1

### Bamboo Fiber Bay Wipe Product

Bamboo fiber baby wipes clean an infant's sensitive skin with a gentle, non-woven fabric cloth that contains active cleansing ingredients. The wipes are made from bamboo fiber, which is a biodegradable material and friendly to the environment. The cloth leaves an infant's skin feeling fresh and clean, and eliminates the risk of irritation by using minimal synthetic preservatives.

Bamboo Fiber Baby Wipes are used as natural cleansing cloths for infants that are also friendly to the environment. The wipes contain 100-percent biodegradable bamboo fiber, which decomposes in approximately 90 days after disposal. The fiber is grown naturally; no pesticides are contributed to the plant during the growth process. The fiber also contains natural antibacterial and deodorizing products. A small amount of mild synthetic preservatives are added to the wipes as an additional cleansing solution. The product also includes one or more isolated essential oils, e.g., sweet orange and/or lavender essential oils.

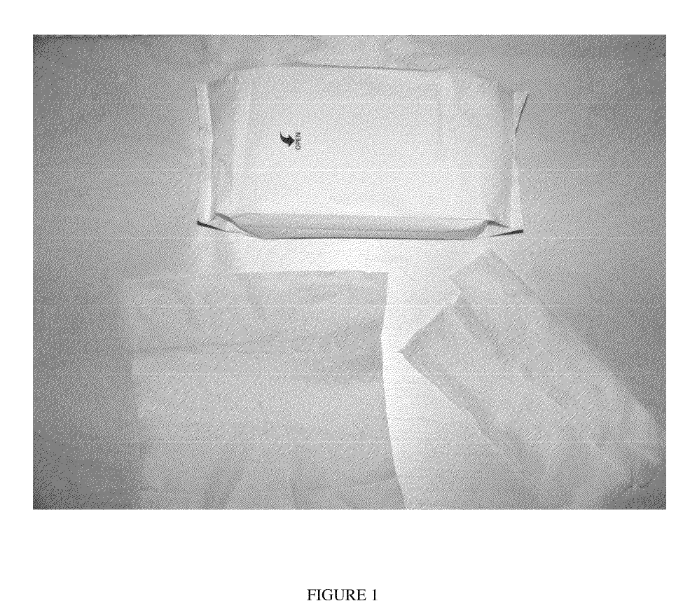

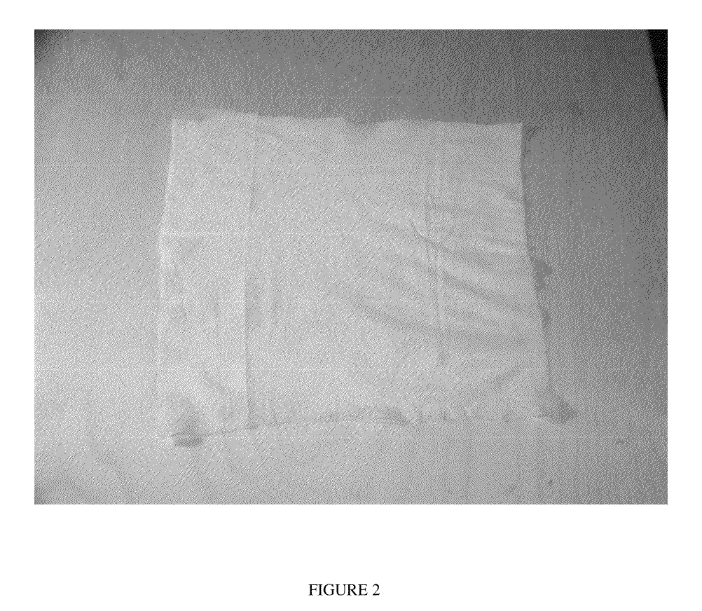

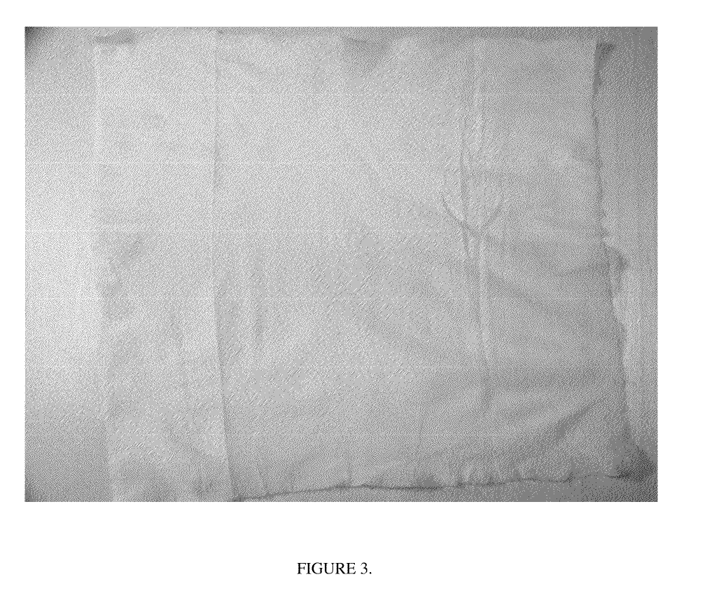

A quantity of wipes is bundled in a plastic container (FIG. 1). One wipe is about three-fourths the size of a standard sheet of paper (FIGS. 2 and 3)

The following is a non-limiting example of a bamboo fiber baby wipe cloth product specification:

Wipe specifications:

Wipe dimensions=5.9×7.9 in or 15×20 cm

Material thickness=45 grams per square meter

Cleaning solution ingredients:
Purified Water (98%)
Organic Aloe Barbadensis (Aloe Vera leaf)—Healing for skin
0.5% Lavender Essential Oil* (Origin: France)—Natural scent, Healing, Anti-viral, Antibacterial
0.5% Sweet Orange Essential Oil* (Origin: Brazil)—Natural scent, Antiseptic
Tocopherol (Vitamin E)—Natural Preservative, Skin Softener
Vegetable Glycerin—Soothes and cleanses skin
Potassium Sorbate Preservative—Preservative

(Sorbate is the metabolized form of the sugar Sorbitol)
Polysorbate 20—Emulsifier
Citric Acid pH—Stabilizer, provides stability *pure essential oil

The following is a non-limiting example of specifications for a package for housing baby wipes.

Container (package) specifications:

Package depth 10 cm

Package width 25 cm

Package height 5 cm

Package gross weight 416 grams,

Package net weight 409 grams

Each package contains 80 wipes.

### Example 2

### Evaluation of Essential Oil Concentrations

### Introduction

There are more than 150 different essential oils which are typically used in aromatherapy. Each oil is associated with at least one of three “note” categories, which are referred to as top, middle, and base notes. Some oils are associated with two or all three categories. Notes are defined as scent characteristics, which denote groups of smells that can be sensed with respect to the time after the exposure to an oil blend. Various notes in the essential oils have influence over the ultimate balance of a blend. Because the note profile of each oil is determined by its chemical constituents and properties (e.g., volatility), superior blends of essential oils are not always achieved by equal parts of constituent essential oils, and the appropriate concentration of each oil in a blend can often be a challenge to identify.

Experiment and Results

An experiment was conducted in order to determine peoples' reactions to different blends of lavender and sweet orange essential oils. Several blends of these lavender and sweet orange essential oils were investigated.

Participants were not informed of notes in essential oils, they were simply asked to rate the blend based on their perception of its balance and pleasant scent. Balance was defined for participants as an essential oil blend that is not overpowered by an individual essential oil, and which also has a pleasant aroma.

11 participants rated the scent of each blend. Each participant was asked to smell the essential oils of lavender and sweet orange individually in order to acquaint their senses with the oil on its own. Next they were asked to rate 5 different blends of lavender and sweet orange essential oil for their balance. Participants' rated the blends on a scale of 1-5, 1 being the least balanced and 5 being the most balanced. The blend with equal parts of lavender and sweet orange essential oils resulted in the highest average rating of 5. The results are outline in table 1.

A blend with equal parts Lavendar and Sweet Orange essential oils achieved the best overall rating.

TABLE 1
Determining Essential Oil Ratio for Bamboo Baby Wipes

| Lavender | sweet orange | | |
|---|---|---|---|
| (parts) | (parts) | Ave Rating | Notes |
| 1 | 1 | 5 | most balanced |
| 2 | 1 | 2 | too medicinal, loses orange |
| 1 | 2 | 4 | too much orange, will lose vibrancy |
| 3 | 1 | 3 | cannot smell orange |
| 1 | 3 | 3 | still too orange, loses lavender |

Rating Scale 1-5 (5 best) asked 11 people

### EQUIVALENTS AND SCOPE

Those skilled in the art will recognize, or be able to ascertain using no more than routine experimentation, many equivalents to the specific embodiments of the invention described herein. The scope of the present invention is not intended to be limited to the above description, but rather is as set forth in the appended claims.

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention encompasses all variations, combinations, and permutations in which one or more limitations, elements, clauses, descriptive terms, etc., from one or more of the claims or from relevant portions of the description is introduced into another claim. For example, any claim that is dependent on another claim can be modified to include one or more limitations found in any other claim that is dependent on the same base claim. As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Furthermore, where the claims recite a composition, it is to be understood that methods of using the composition for any of the purposes disclosed herein are included, and methods of making the composition according to any of the methods of making disclosed herein or other methods known in the art are included, unless otherwise indicated or unless it would be evident to one of ordinary skill in the art that a contradiction or inconsistency would arise. In addition, the invention encompasses compositions made according to any of the methods for preparing compositions disclosed herein.

Where elements are presented as lists, e.g., in Markush group format, it is to be understood that each subgroup of the elements is also disclosed, and any element(s) can be removed from the group. It is also noted that the term “comprising” is intended to be open and permits the inclusion of additional elements or steps. It should be understood that, in general, where the invention, or aspects of the invention, is/are referred to as comprising particular elements, features, steps, etc., certain embodiments of the invention or aspects of the invention consist, or consist essentially of, such elements, features, steps, etc. For purposes of simplicity those embodiments have not been specifically set forth in haec verba herein. Thus for each embodiment of the invention that comprises one or more elements, features, steps, etc., the invention also provides embodiments that consist or consist essentially of those elements, features, steps, etc.

Where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

In addition, it is to be understood that any particular embodiment of the present invention may be explicitly excluded from any one or more of the claims. Any embodiment, element, feature, application, or aspect of the compositions and/or methods of the invention, can be excluded from any one or more claims. For purposes of brevity, all of the embodiments in which one or more elements, features, purposes, or aspects is excluded are not set forth explicitly herein.

1. A composition, comprising:
bamboo fibers and at least one isolated essential oil, wherein the bamboo fibers are in the form of a cloth.

2. The composition of claim 1, wherein the at least one isolated essential oil is selected from the group consisting of sage, thyme, winter savory, mandarin, grapefruit, bitter orange, sweet orange, lime, lemon, chamomile, dill, lavender, neroli, rose, tarragon, rosemary, peppermint, cinnamon, geranium, rosemary, orange, clove and yarrow essential oils.

3.-10. (canceled)

11. The composition of claim 1, wherein one of the at least one isolated essential oil is a lavender essential oil.

12. The composition of claim 1 or 11, wherein one of the at least one isolated essential oil is a citrus essential oil.

13. The composition of claim 12, wherein the citrus oil is selected from the group consisting of lime, lemon, mandarin, grapefruit, bitter orange, and sweet orange essential oils.

14. (canceled)

15. The composition of claim 1, wherein the composition comprises a mixture of the isolated essential oil and an aqueous solution.

16. The composition of claim 15, wherein the volume of the at least one isolated essential oil ranges from about 0.1% to about 5% of the volume of the aqueous solution.

17.-19. (canceled)

20. The composition of claim 1, wherein the bamboo fibers are non-woven bamboo fibers.

21. The composition of claim 1, wherein the bamboo fibers are woven bamboo fibers.

22. (canceled)

23. The composition of claim 1, wherein the cloth has a length ranging from about 5 cm to about 25 cm and a width ranging from about 10 cm to about 30 cm.

24. (canceled)

25. The composition of claim 1, wherein the cloth has a weight ranging from about 25 cm to about 65 grams per square meter.

26. (canceled)

27. The composition of claim 1, wherein the composition comprises bamboo fibers of a bamboo species selected from the group consisting of Acidosasa sp., Ampleocalamus sp., Arundinaria sp., Bambusa sp., Bashania sp., Borinda sp., Brachystachyum sp., Cephalostachyum sp., Chimonobambusa sp., Chusquea sp., Dendrocalamus sp., Dinochloa sp., Drepanostachyum sp., Eremitis sp., Fargesia sp., Gaoligongshania sp., Gelidocalamus sp., Gigantocloa sp., Guadua sp., Hibanobambusa sp., Himalayacalamus sp., Indocalamus sp., Indosasa sp., Lithachne sp., Melocanna sp., Menstruocalamus sp., Nastus sp., Neohouzeaua sp., Neomicrocalamus sp., Ochlandra sp., Oligostachyum sp., Olmeca sp., Otatea sp., Oxytenanthera sp., Phyllostachys sp., Pleioblastus sp., Pseudosasa sp., Raddia sp., Rhipidocladum sp., Sasa sp., Sasaella sp., Sasamorpha sp., Schizostachyum sp., Semiarundinaria sp., Shibatea sp., Sinobambusa sp., Thamnocalamus sp., Thyrsostachys sp., and Yushania sp.

28.-42. (canceled)

43. A method of cleaning a substrate, the method comprising:
contacting the substrate with the composition of claim 1.

44.-47. (canceled)

48. The method of claim 43, wherein the substrate is skin, wood, plastic, ceramic, glass or metal.

49.-50. (canceled)

51. A cleaning product, comprising:
a container housing bamboo fibers and a isolated essential oil the composition of claim 1.

52.-59. (canceled)

60. The cleaning product of claim 51, wherein the container houses about 50 to about 100 cloths.

61. (canceled)

62. The cleaning product of claim 51, wherein the container is a rigid container.

63. The cleaning product of claim 51, wherein the container is a flexible container.
